(19) United States
(12) Patent Application Publication
(10) Pub. No.: US 2016/0089957 A1
(43) Pub. Date: Mar. 31, 2016

(54) AC SYSTEM WITH PROPORTIONAL CONTROLLED HYDRAULIC FAN

(71) Applicant: INTERNATIONAL TRUCK INTELLECTUAL PROPERTY COMPANY, LLC, Lisle, IL (US)

(72) Inventors: Jose Antonio Marques Neto, Darien, IL (US); William McCoy, Fort Wayne, IN (US); William Laroy Barbrey, DeKalb, IL (US); Andrew Joseph Arendas, Lake Villa, IL (US)

(73) Assignee: International Truck Intellectual Property Company, LLC, Lisle, IL (US)

(21) Appl. No.: 14/891,213

(22) PCT Filed: May 29, 2013
(86) PCT No.: PCT/US13/43097

§ 371 Date: Nov. 13, 2015

(51) Int. Cl. B60H 1/00; B60H 1/32; F01P 11/16; F01P 7/04; F01P 9/06

(52) U.S. Cl. CPC B60H 1/00885; F01P 7/044; F01P 9/06; F01P 11/16; B60H 1/3205; B60H 1/323; B60H 1/3232

(57) ABSTRACT

A system and method for improving the operation of a cooling system and AC system for an engine, without sacrificing engine performance is disclosed. The system includes a cooling module positioned within an engine compartment of the vehicle, a cooling fan mounted in front of the cooling module, and a control strategy for controlling operation of the cooling fan based on engine conditions. The system includes incorporating at least one sensor, include a pressure sensor installed within the high pressure side of the AC system. The method includes providing an AC system having a high pressure side and a low pressure side, providing at least one sensor on the high pressure side for producing an electrical signal in response to an operating condition, determining which sensor has a highest electrical signal value for controlling the speed of the fan.

### TECHNICAL FIELD

The present system and method relate to improving air conditioner (AC) efficiency in a vehicle. More specifically, the system and method relate to controlling fan speed and air flow through an AC system in response to temperatures and system pressures while minimizing engine performance penalties generally associated with an AC system.

### BACKGROUND

Vehicles having fluid cooled engines typically include an engine driven fan arranged to move air across a heat exchanger or cooling module. The engine coolant picks up heat from the engine and circulates through the heat exchanger, which cools the fluid and readies it for another cycle through the engine. In various types of commercial equipment the fan is advantageously operated by a hydraulic motor, allowing the heat exchanger and fan assembly to be located at any convenient point on the vehicle.

Some engines, including those for diesel engines, incorporate a fan for use in connection with the cooling module for the engine and the air conditioning (AC) system. The AC system is a standard loop system having a high pressure side and a low pressure side. Thus, the single fan accommodates cooling requirements for both the engine and the air conditioning (AC) system. High fan power consumption and excessive air flow through the condenser make system pressures vary excessively, reducing AC system efficiency. Therefore, controlling the fan speed proportional to the high pressure side of the AC system would maximize the performance of the fan and minimize the engine performance penalties associated with operation of the fan.

Furthermore, the heavy duty engine business is extremely competitive. Increased demands are being placed on engine manufacturers to design and build engines that provide better engine performance, improved reliability, and greater durability while meeting more stringent emission and noise requirements. Along with all of these, perhaps the greatest customer demand is to provide engines that are more fuel efficient. Demands for fuel efficiency are becoming so great, that all engine driven systems in the vehicle are being scrutinized in attempts to reduce power consumption when possible.

Therefore, it is advantageous to operate the cooling fan at a speed proportional to that necessary to sufficiently cool the vehicle engine and efficiently operate the AC system. Such controlled operation enables the vehicle engine to operate in a desired temperature range and also serves to conserve fuel. Therefore, the present system includes a hydraulically driven, variable speed fan that will increase and decrease speed proportionally based on AC high side pressure sensor readings, or alternatively, on coolant and air temperature sensor readings to efficiently drive the fan.

### SUMMARY

There is disclosed herein an improved system and method for improving the operation of a cooling system and AC system for an engine, without sacrificing engine performance and avoiding the disadvantages of prior systems while affording additional structural and cost advantages.

In an embodiment, a system for controlling fan speed in a cooling system of vehicle, is disclosed. The system comprises a cooling module positioned within an engine compartment of the vehicle, a cooling fan mounted in front of the cooling module, and a control strategy for controlling operation of the cooling fan based on engine conditions.

In another embodiment, a system for controlling fan speed in a cooling system of an engine, is disclosed. The system comprises a cooling module mounted within an engine compartment of the engine, the cooling module comprising a radiator coupled to a charge air cooler coupled to an AC condenser, a variable speed cooling fan mounted in front of the cooling module, and a control strategy for controlling operation of the cooling fan, wherein the control strategy includes at least one sensor producing an electrical signal for increasing and decreasing the speed of the cooling fan based on the signal reading.

A method for controlling speed of a fan in a cooling system of an engine, is disclosed. The method comprises the steps of providing an AC system having a high pressure side and a low pressure side, providing at least one sensor on the high pressure side for producing an electrical signal in response to an operating condition, determining which sensor has a highest electrical signal value, presenting the highest signal value to the fan, and controlling the speed of the fan based the highest electrical signal value while minimizing engine performance penalties.

Additional embodiments and features of the system and can be understood from the appended drawings and the detailed description below.

### BRIEF DESCRIPTION OF THE DRAWINGS

FIG. 1 is a schematic illustrating a cooling module utilizing the present fan speed control system;

FIG. 2 is schematic illustrating the present fan speed control system;

FIG. 3 is a schematic illustrating the present fan speed control system;

FIG. 4 is an illustration of the location of one of the sensors useful in the present fan speed control system in relation to the AC condenser; and,

FIG. 5 is a graph illustrating the proportional relationship between the fan speed and the AC high side pressure.

### DETAILED DESCRIPTION

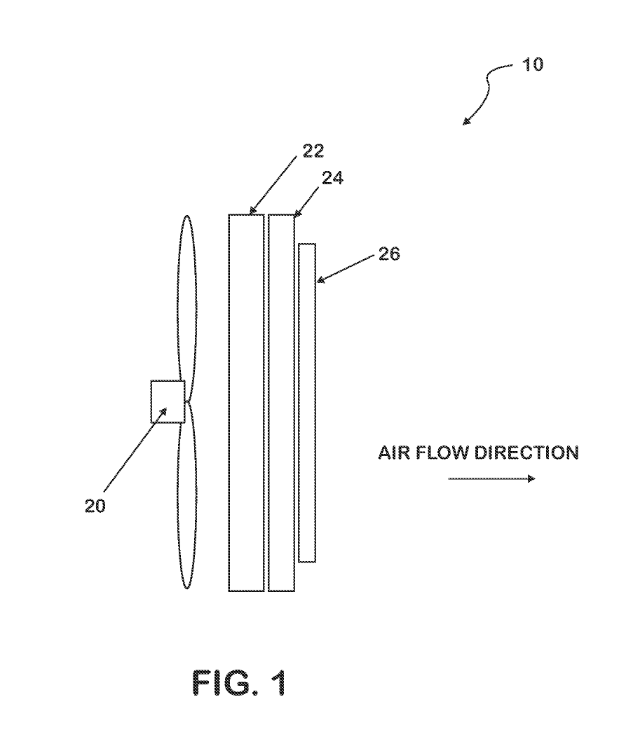

With reference to FIGS. 1-5, an embodiment of the fan speed control system, generally indicated in the appended drawings by the numeral 100. The fan speed control system is for use in the cooling and AC system, designated by the numeral 10 of a vehicle (not shown). The fan speed control system 100 and its components are identified consistently throughout the drawing figures.

Cooling and AC systems for vehicles, their components and operation, are well known. FIG. 1 illustrates an embodiment of a cooling module 10 for use in an internal combustion engine (not shown) for use in both engine cooling and the AC system. In this embodiment, the cooling module includes a hydraulically driven fan 20 positioned in close proximity to a radiator 22, charge air cooler 24 and AC condenser 26. Although not shown, it should be understood that the hydraulically driven fan may also include other components for its operation such as a fluid motor connected to a pump and is powered by hydraulic fluid supplied by the pump from a reservoir.

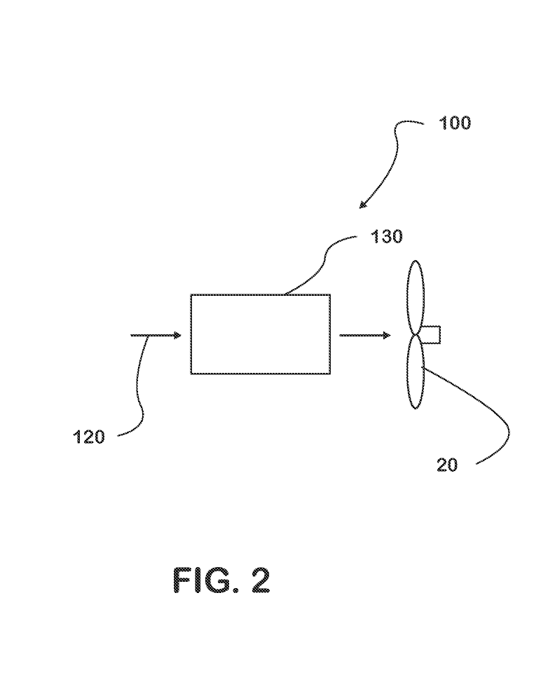

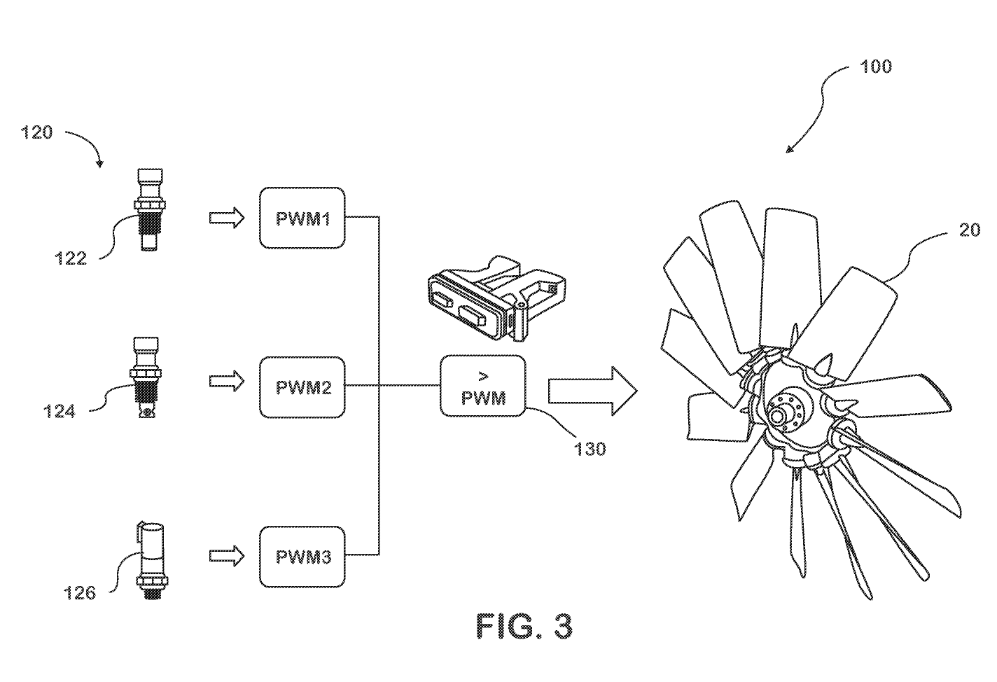

It is appreciated that some embodiments of the present fan speed control system 100 are most suited for a hydraulically driven fan system, but some embodiments may be used alternatively with other types of fan systems. FIGS. 2 and 3 illustrate an embodiment of the fan control system 100 of the present disclosure. Sensors 120 are in electrical communication with a controller 130 via input ports (not shown). The controller 122 preferably includes a microprocessor (not shown) in communication with various computer readable storage media (not shown) via data and control bus (not shown). Computer readable storage media may include any of a number of known devices which function as read only memory, random access memory, and non-volatile random access memory.

As shown in FIG. 3, the sensors 120 may include several different types of sensors for determining various engine conditions. For example, the sensors may include a coolant temperature sensor 122, an intake air temperature sensor 124 or an AC high side pressure sensor 126. In operation, the controller 130 receives signals, specifically a pulse width modulation (PMW) signal from sensors 120 and executes control logic embedded in hardware and/or software to control the variable speed of the fan 20. In particular, the operation of the fan 20 is controlled by an applied fan request signal from one of the sensors 120 that commands the fan system. Essentially, the sensor, 122, 124 or 126 generating the highest fan speed request or signal is the one that controls and drives the variable speed of the fan 20.

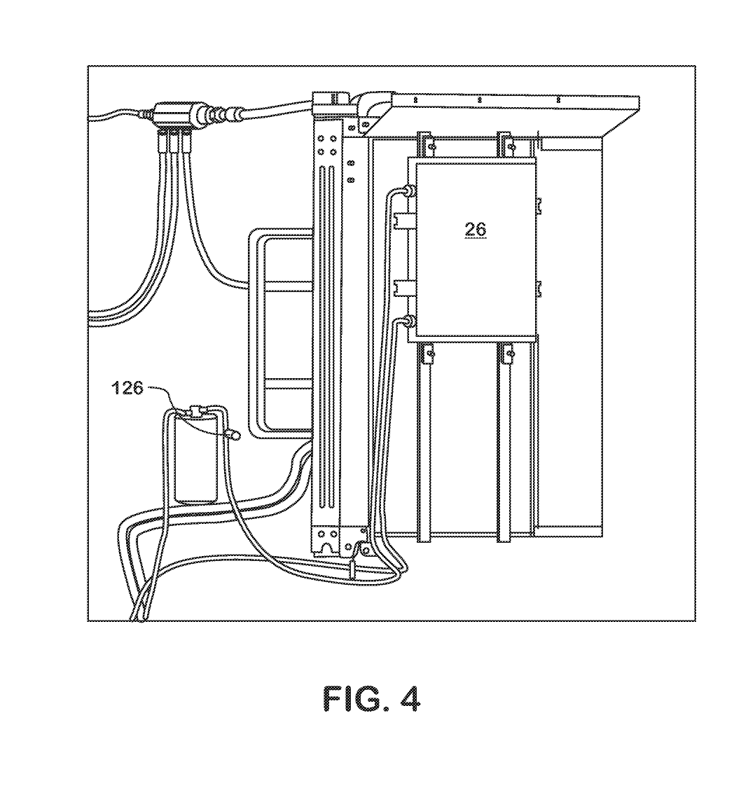

As previously noted, high fan power consumption and excessive air flow through the condenser can make the overall system pressures very excessively and reduce the efficiency of the AC system. Installing an AC pressure sensor 126 within the high side of the AC system, as shown in FIG. 4, will provide the ability to proportionally control the fan speed based on the high side pressure readings of the AC system. Controlling the fan speed will maximize the performance of the AC system, while minimizing any engine performance penalties.

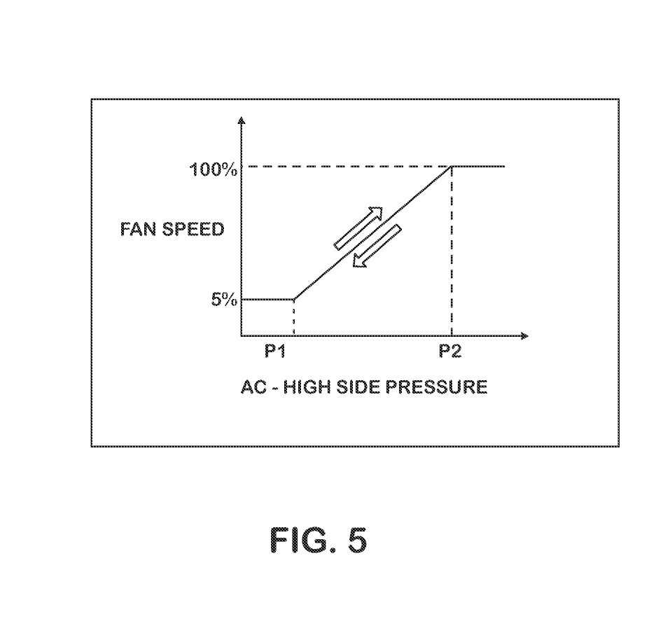

FIG. 5 provides a graphic of the proportional control of the fan speed, which ramps up or down with the increase or decrease of the AC high side pressure in a closed loop control strategy. Thus, unlike a mechanically driven fan, the hydraulically driven fan will increase and decrease speed proportionally based on the AC high side pressure sensor reading. Alternatively, as shown in FIG. 3, if the coolant sensor 122 or intake air temperature sensor 124 provides the highest signal value to the fan, that condition will control the operation of the fan speed.

Controlling the speed of the fan 20, in particular in proportion to the AC high side pressure reading of the sensor 126 results in a decrease in unnecessary fan power consumption affecting vehicle performance and/or fuel consumption.

What is claimed is:

1. A system for controlling fan speed in a cooling system of a vehicle, the system comprising:
a cooling module positioned within an engine compartment of the vehicle;
a cooling fan mounted in front of the cooling module; and,
a control strategy for controlling operation of the cooling fan based on engine operating conditions.

2. The system of claim 1, wherein the cooling module includes a radiator, a charge air cooler and a condenser.

3. The system of claim 1, wherein the cooling fan is a hydraulically driven fan.

4. The system of claim 1, wherein the control strategy includes a plurality of sensors for controlling operation of the cooling fan.

5. The system of claim 4, wherein the sensors include a coolant temperature sensor, an intake air sensor and an AC high side pressure sensor

6. The system of claim 4, wherein the sensor with a highest signal controls the operation of the cooling fan.

7. The system of claim 6, wherein controlling the operation of the cooling fan includes controlling a speed level of the cooling fan.

8. The system of claim 7, wherein the speed level of the cooling fan increase and decreases proportionally based on the AC high side pressure sensor readings.

9. The system of claim 8, wherein the AC high side pressure sensor further includes a pressure transducer for converting any applied pressure into an electrical signal for controlling the speed level of the cooling fan.

10. A fan speed control system for use in a cooling system of an engine, the system comprising:
a cooling module mounted within an engine compartment of the engine, the cooling module comprising a radiator coupled to a charge air cooler coupled to an AC condenser;
a variable speed cooling fan mounted in front of the cooling module; and,
a control strategy for controlling operation of the cooling fan, wherein the control strategy includes at least one sensor producing an electrical signal for increasing and decreasing the speed of the cooling fan based on the signal reading.

11. The system of claim 10, wherein the sensor is pressure sensor connected to a high pressure side of an AC system of the cooling system of the engine.

12. A method for controlling speed of a fan in a cooling system of an engine, the method comprising the steps of:
providing an AC system having a high pressure side and a low pressure side;
providing at least one sensor on the high pressure side for producing an electrical signal in response to an operating condition;
determining which sensor has a highest electrical signal value;
presenting the highest signal value to the fan; and,
controlling the speed of the fan based the highest electrical signal value while minimizing engine performance penalties.

13. The method of claim 12, wherein the sensor includes a pressure transducer for converting applied pressure from the high pressure side of the AC system into the highest signal value.

14. The method of claim 12, wherein the step of determining which sensor has the highest electrical signal value based on engine conditions further includes selecting the highest electrical signal value from one of the engine conditions including a coolant temperature sensor, an intake air temperature sensor and AC system high side pressure sensor.

15. The method of claim 12, wherein the step of controlling the speed of the fan includes increasing the speed of the fan in proportion to an increase in heat load requirements for an AC system.
